(19) United States
(12) Patent Application Publication
(10) Pub. No.: US 2018/0033390 A1
(43) Pub. Date: Feb. 1, 2018

(54) ELECTROOPTICAL DEVICE, ELECTRONIC APPARATUS, AND METHOD FOR DRIVING ELECTROOPTICAL DEVICE

(71) Applicant: SEIKO EPSON CORPORATION, Tokyo (JP)

(72) Inventors: Hiroyuki HOSAKA, Matsumoto-shi (JP); Suguru UCHIYAMA, Suwa-shi (JP); Nariya TAKAHASHI, Chino-shi (JP)

(73) Assignee: SEIKO EPSON CORPORATION, Tokyo (JP)

(21) Appl. No.: 15/640,786

(22) Filed: Jul. 3, 2017

(30) Foreign Application Priority Data
Jul. 26, 2016 (JP) 2016-146171

(51) Int. Cl. G09G 3/36

(52) U.S. Cl. CPC G09G 3/3677; G09G 3/3648; G09G 3/3696; G09G 2320/0233; G09G 2310/08

(57) ABSTRACT

A first supply circuit supplies first data signals to respective signal lines in a wiring group via first data lines, and supplies first selection signals via four first selection signal lines. A second supply circuit supplies second data signals to respective signal lines in the other wiring group via second data lines, and supplies second selection signals via four second selection signal lines. A control circuit exclusively supplies the first selection signals from the first supply circuit and the second selection signals from the second supply circuit.

### BACKGROUND

### 1. Technical Field

The present invention relates to an electrooptical device, an electronic apparatus, and a method for driving an electrooptical device.

### 2. Related Art

In a high-definition electrooptical device, in a case where only a single driving circuit outputs data signals, a large load is applied to the single driving circuit. As a method of reducing the load, a method of outputting data signals using a plurality of (two) driving circuits is known (refer to JP-A-2007-212956).

Meanwhile, there is a case where the electrooptical device includes distribution circuits such as demultiplexers that distribute the data signals output from the driving circuits to a plurality of signal lines according to selection signals. Here, the selection signals for the distribution circuits can be output from each of the driving circuits in addition to the data signals. In this case, a case that controls the distribution circuits using only the selection signals output from any one of the plurality of driving circuits, is considered.

However, in this case, there is a difference in a load due to an operating condition in which the driving circuits supply or do not supply the selection signals to the distribution circuits. In the driving circuit that does not supply the selection signals to the distribution circuits, there is no variation in the power supply voltage due to the output of the selection signals. However, in the driving circuit that supplies the selection signals to the distribution circuits, the power supply voltage varies due to the output of the selection signals. The difference in the operating condition causes variations in the data signals between the driving circuits, and this may cause deterioration in image quality.

### SUMMARY

An advantage of some aspects of the invention is to perform display with high definition and high quality by equalizing the load of each of the supply circuits in the case of driving the electrooptical device using a plurality of supply circuits which generate the data signals and the selection signals.

An electrooptical device according to an aspect of the invention includes: a plurality of first pixels that are disposed corresponding to the respective intersections between a plurality of first signal lines which belong to a first signal line group and a plurality of scanning lines, and that display gradation according to first data signals supplied to the first signal lines when the scanning lines are selected; a plurality of second pixels that are disposed corresponding to the respective intersections between a plurality of second signal lines which belong to a second signal line group and a plurality of scanning lines, and that display gradation according to second data signals supplied to the second signal lines when the scanning lines are selected; a first distribution circuit that distributes the first data signals to the first signal lines according to first selection signals or second selection signals; a second distribution circuit that distributes the second data signals to the second signal lines according to first selection signals or second selection signals; a first supply circuit that supplies the first data signals and the first selection signals; a second supply circuit that supplies the second data signals and the second selection signals; and a control circuit that exclusively supplies the first selection signals and the second selection signals.

According to this aspect, the first selection signals are supplied from the first supply circuit to the first distribution circuit. In addition, the second selection signals are supplied from the second supply circuit to the first distribution circuit. Similarly, the first selection signals are supplied from the first supply circuit to the second distribution circuit. In addition, the second selection signals are supplied from the second supply circuit to the second distribution circuit. Therefore, the load of the supply of the selection signals in the supply circuits is distributed to the first supply circuit and the second supply circuit, compared to a case where the selection signals are supplied from a single supply circuit to the first distribution circuit and the second distribution circuit. As a result, it is possible to prevent deterioration in image quality such as a decrease in luminance.

An electrooptical device according to another aspect of the invention includes: a plurality of pixels that are disposed corresponding to the respective intersections between 2K (K is a natural number of two or more) or more signal lines and two or more scanning lines, and that display gradation according to signals supplied to the signal lines when the scanning lines are selected; a scanning line driving circuit that sequentially selects the respective scanning lines; a first supply circuit that supplies first data signals to the respective signal lines in first signal line groups each with the K signal lines via first data lines, and that supplies first selection signals via K-P (P is a natural number of one or more) first selection signal lines; a second supply circuit that supplies second data signals to the respective signal lines in second signal line groups each with the K signal lines different from the K signal lines which belong to the first signal line groups via second data lines, and that supplies second selection signals via P second selection signal lines; a first distribution circuit that is connected to the respective signal lines in the first signal line groups, the first data lines, the K-P first selection signal lines, and the P second selection signal lines, and that supplies the first data signals to the respective signal lines in the first signal line groups according to the first selection signals or the second selection signals supplied via the first selection signal lines or the second selection signal lines; a second distribution circuit that is connected to the respective signal lines in the second signal line groups, the second data lines, the K-P first selection signal lines, and the P second selection signal lines, and that supplies the second data signals to the respective signal lines in the first signal line groups according to the first selection signals or the second selection signals supplied via the first selection signal lines or the second selection signal lines; and a control circuit that exclusively supplies the first selection signals from the first supply circuit and the second selection signals from the second supply circuit.

According to this aspect, the first selection signals are supplied from the first supply circuit to the first distribution circuit via the K-P first selection signal lines. In addition, the second selection signals are supplied from the second supply circuit to the first distribution circuit via the P second selection signal lines. Similarly, the first selection signals are supplied from the first supply circuit to the second distribution circuit via the K-P first selection signal lines. In addition, the second selection signals are supplied from the second supply circuit to the second distribution circuit via the P second selection signal lines. Therefore, the load of the supply of the selection signals in the supply circuits is distributed to the first supply circuit and the second supply circuit, compared to a case where the selection signals are supplied from a single supply circuit to the first distribution circuit and the second distribution circuit via the K selection signal lines. As a result, it is possible to prevent deterioration in image quality such as a decrease in luminance.

In the electrooptical device according to the aspect, preferably, P is K/2. According to this aspect, the load of the supply of the selection signals in the supply circuits is equally distributed to the first supply circuit and the second supply circuit, compared to a case where the selection signals are supplied from a single supply circuit to the first distribution circuit and the second distribution circuit via the K selection signal lines. As a result, it is possible to prevent the occurrence of a difference such as a decrease in luminance between when the first supply circuit supplies the selection signals and when the second supply circuit supplies the selection signals. Thus, it is possible to prevent deterioration in image quality.

In the electrooptical device according to the aspect, preferably, the K-P first selection signal lines and the P second selection signal lines are connected to the first distribution circuit so as to alternately correspond to the respective signal lines in the first signal line groups, and are connected to the second distribution circuit so as to alternately correspond to the respective signal lines in the second signal line groups. According to this aspect, the load of the supply of the selection signals in the supply circuits is equally distributed to the first supply circuit and the second supply circuit, compared to a case where the selection signals are supplied from a single supply circuit to the first distribution circuit and the second distribution circuit via the K selection signal lines. As a result, it is possible to prevent the occurrence of a difference such as a decrease in luminance between when the first supply circuit supplies the selection signals and when the second supply circuit supplies the selection signals. Thus, it is possible to prevent deterioration in image quality.

In the electrooptical device according to the aspect, preferably, the first supply circuit has a function of supplying the first selection signals via the K first selection signal lines or the second selection signal lines, and the second supply circuit has a function of supplying the second selection signals via the K second selection signal lines. According to this aspect, the load of the supply of the selection signals in the supply circuits is equally distributed to the first supply circuit and the second supply circuit, compared to a case where the selection signals are supplied from a single supply circuit to the first distribution circuit and the second distribution circuit via the K selection signal lines. In addition, since the first supply circuit and the second supply circuit both have a function of supplying the first selection signals or the second selection signals via the K first selection signal lines or the second selection signal lines, it is possible to supply the first selection signals or the second selection signals with a time margin. As a result, it is possible to prevent the occurrence of a difference such as a decrease in luminance between when the first supply circuit supplies the selection signals and when the second supply circuit supplies the selection signals. Thus, it is possible to prevent deterioration in image quality.

In the electrooptical device according to the aspect, preferably, the first supply circuit is provided on a first wiring board, the second supply circuit is provided on a second wiring board, and the first wiring board and the second wiring board are attached so as to overlap each other when viewed from the display direction of the pixels. According to this aspect, it is possible to reduce the size of the electrooptical device.

In the electrooptical device according to the aspect, preferably, the first data lines and the second data lines are alternately disposed side by side. According to this aspect, the pitch between the data lines including the first data lines and the second data lines can be narrower than the pitch between only the first data lines or the pitch between only the second data lines. In addition, it becomes easier to alternately dispose the pixel group to which the first data signals are supplied and the pixel group to which the second data signals are supplied. In this case, it is possible to make a difference in image quality between the pixel groups inconspicuous.

In the electrooptical device according to the aspect, preferably, a plurality of the first signal line groups and a plurality of the second signal line groups are respectively provided, and the first signal line groups and the second signal line groups are alternately disposed. According to this aspect, it is possible to alternately dispose the pixel groups driven by the data signals from the different supply circuits. Therefore, it is possible to make a difference in image quality between the pixel groups driven by the data signals from the different supply circuits inconspicuous.

An electronic apparatus according to still another aspect of the invention includes the above-described electrooptical device. The electrooptical device can prevent deterioration in image quality.

A method for driving an electrooptical device according to still another aspect of the invention, includes: supplying first data signals and first selection signals by a first supply circuit; supplying second data signals and second selection signals by a second supply circuit; distributing the first data signals to first signal lines according to the first selection signals or the second selection signals, by a first distribution circuit; distributing the second data signals to second signal lines according to the first selection signals or the second selection signals, by a second distribution circuit; displaying gradation according to the first data signals supplied to the first signal lines when scanning lines are selected, by first pixels that are disposed corresponding to respective intersections between the first signal lines and the scanning lines; displaying gradation according to the second data signals supplied to the second signal lines when the scanning lines are selected, by second pixels that are disposed corresponding to respective intersections between the second signal lines and the scanning lines; and exclusively supplying the first selection signals from the first supply circuit and the second selection signals from the second supply circuit, by a control circuit.

According to this aspect, the first selection signals are supplied from the first supply circuit to the first distribution circuit. In addition, the second selection signals are supplied from the second supply circuit to the first distribution circuit. Similarly, the first selection signals are supplied from the first supply circuit to the second distribution circuit. In addition, the second selection signals are supplied from the second supply circuit to the second distribution circuit. Therefore, the load of the supply of the selection signals in the supply circuits is distributed to the first supply circuit and the second supply circuit, compared to a case where the selection signals are supplied from a single supply circuit to the first distribution circuit and the second distribution circuit. As a result, it is possible to prevent deterioration in image quality such as a decrease in luminance.

### BRIEF DESCRIPTION OF THE DRAWINGS

The invention will be described with reference to the accompanying drawings, wherein like numbers reference like elements.

FIG. 1 is a diagram illustrating a configuration of a signal transmission system of an electrooptical device according to a first embodiment of the invention.

FIG. 2 is a perspective view of the opposite surface of the electrooptical device.

FIG. 3 is a block view illustrating a configuration of the electrooptical device.

FIG. 4 is a circuit diagram of each pixel.

FIG. 5 is an explanatory diagram of an operation of the electrooptical device.

FIG. 6 is a block view illustrating a configuration of a part of the electrooptical device.

FIG. 7 is a diagram illustrating an arrangement of connection terminals of flexible printed circuit boards in a modification example.

FIG. 8 is a perspective view illustrating a form of an electronic apparatus (a projection type display apparatus).

### DESCRIPTION OF EXEMPLARY EMBODIMENTS

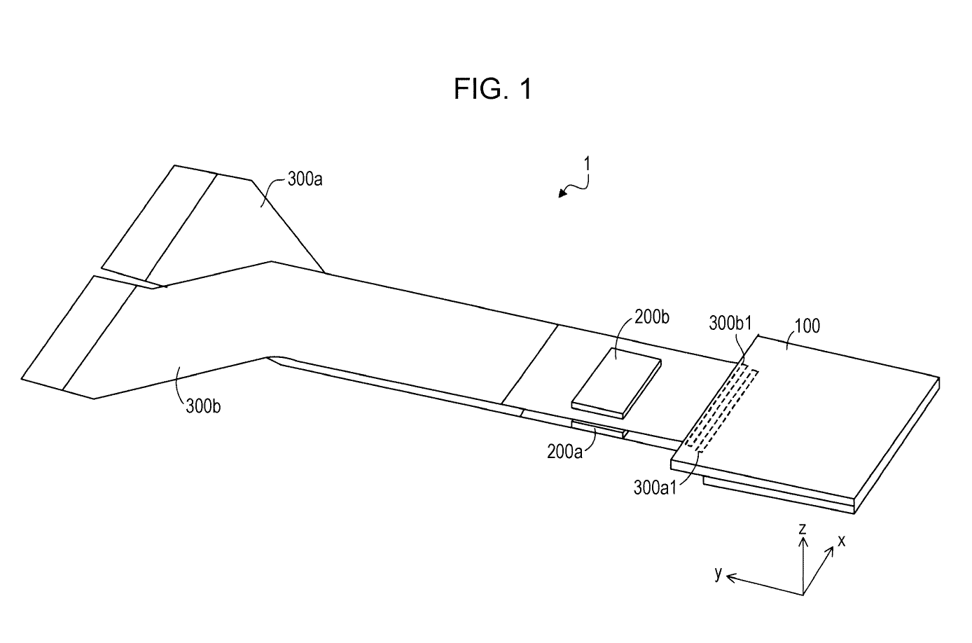

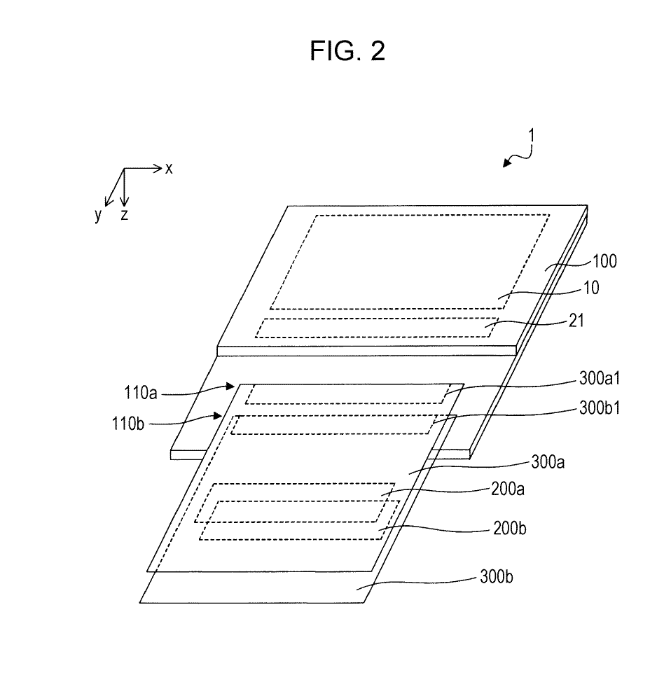

FIG. 1 is a diagram illustrating a configuration of a signal transmission system of an electrooptical device 1 according to an embodiment of the invention. The electrooptical device 1 includes an electrooptical panel 100, a first supply circuit 200a, a second supply circuit 200b, a flexible printed circuit board 300a as a first wiring board, and a flexible printed circuit board 300b as a second wiring board. The electrooptical device 1 may be, for example, a device which has the number of pixels of 3840×2160 obtained by respectively doubling the number of pixels of full hi-vision in the vertical direction and the horizontal direction. Each of the first supply circuit 200a and the second supply circuit 200b is, for example, a driving integrated circuit. FIG. 2 is a perspective view illustrating a configuration example of the electrooptical device 1 according to a first embodiment in which the invention is adopted. FIG. 2 is a perspective view of the opposite surface of a main portion of FIG. 1.

The electrooptical device 1 has a configuration in which the flexible printed circuit boards 300a and 300b are connected to one side of the electrooptical panel 100.

The first supply circuit 200a is mounted on the flexible printed circuit board 300a by a chip on film (COF) technology. The second supply circuit 200b is mounted on the flexible printed circuit board 300b by the COF technology. The flexible printed circuit board 300a is stacked on the flexible printed circuit board 300b. The first supply circuit 200a is stacked on the second supply circuit 200b. As described above, in this embodiment, the flexible printed circuit board 300a and the flexible printed circuit board 300b are attached to the electrooptical panel 100 such that a part of the flexible printed circuit board 300a and a part of the flexible printed circuit board 300b overlap in a direction (z direction) perpendicular to the display surface of the electrooptical panel 100.

The electrooptical panel 100 includes a first input unit 110a and a second input unit 110b. The first input unit 110a is an input terminal group. The first input unit 110a receives, for example, various signals output from the first supply circuit 200a via the flexible printed circuit board 300a. The second input unit 110b is an input terminal group. The second input unit 110b receives, for example, various signals output from the second supply circuit 200b via the flexible printed circuit board 300b. The electrooptical panel 100 is driven based on various signals received by the first input unit 110a and various signals received by the second input unit 110b.

Wiring (not illustrated in FIGS. 1 and 2) for transmitting signals is provided on the flexible printed circuit boards 300a and 300b.

The first input unit 110a and the second input unit 110b of the electrooptical panel 100 are respectively connected to the connection terminal 300a1 of the flexible printed circuit board 300a and the connection terminal 300b1 of the flexible printed circuit board 300b. The electrooptical panel 100 is connected to a control circuit as a higher circuit (not illustrated) via the flexible printed circuit board 300a and the first supply circuit 200a and via the flexible printed circuit board 300b and the second supply circuit 200b.

The first supply circuit 200a and the second supply circuit 200b respectively receive image signals and various signals for driving control, from the control circuit via the flexible printed circuit boards 300a and 300b. The first supply circuit 200a and the second supply circuit 200b respectively drive the electrooptical panel 100 via the flexible printed circuit boards 300a and 300b.

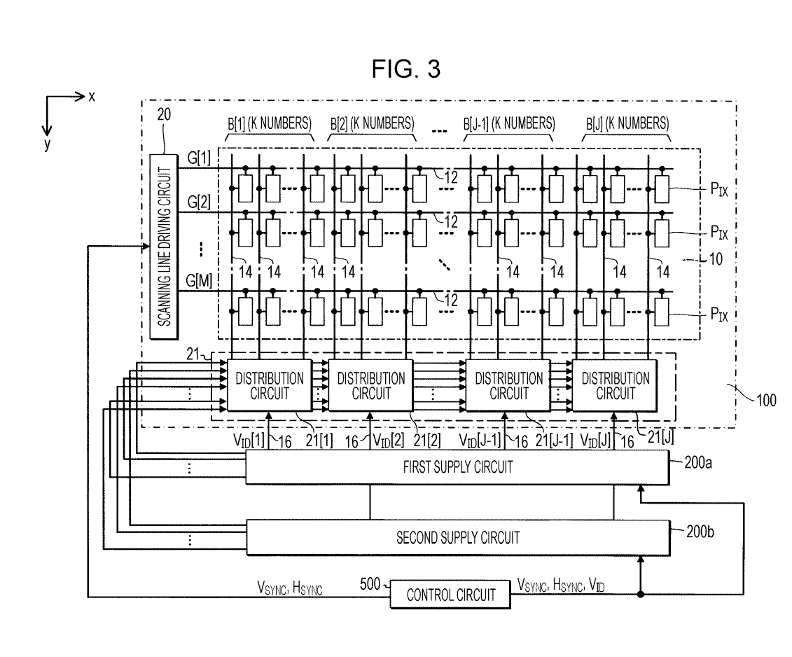

FIG. 3 is a block diagram illustrating configurations of the electrooptical panel 100, the first supply circuit 200a, and the second supply circuit 200b.

The electrooptical panel 100 includes a pixel unit 10 in which a plurality of pixels P_{IX} (pixel circuits) are arranged in a plane, a scanning line driving circuit 20, and a distribution circuit group 21.

In the pixel unit 10, M scanning lines 12 and N signal lines 14 that intersect with each other via an insulating layer are formed (M is a natural number of two or more, and N is a number of 2K or more (K is a natural number of two or more)). The plurality of pixels P_{IX} are disposed corresponding to the intersections between the respective scanning lines 12 and the respective signal lines 14. Therefore, the plurality of pixels P_{IX} are arranged in a matrix shape of M rows in the longitudinal direction×N columns in the transverse direction. The plurality of pixels P_{IX} display the gradation according to the potential of the signal lines 14 when the scanning lines 12 are selected. The scanning lines 12 extend from the scanning line driving circuit 20 along the row direction (x direction), and the signal lines 14 extend from the distribution circuit group 21 along the column direction (y direction).

Although the entire area of the pixel unit 10 may be used as a display effective area, a part of the peripheral portion of the pixel unit 10 may be used as a non-display area, and the scanning lines 12, the signal lines 14, and the pixels P_{IX} in the peripheral portion may be disposed as dummy scanning lines, dummy signal lines, and dummy pixels.

The N signal lines 14 in the pixel unit 10 are divided into J wiring groups (blocks) B[j] (j is a natural number of 1J, J=N/K) each with K signal lines 14 as a unit. That is, the signal lines 14 are grouped for each wiring block B. The J wiring groups B[1] to B[J] correspond to J data lines 16[1] to 16[J] in a one-to-one correspondence. In this embodiment, since J is an even number of two or more and K signal lines 14 of one unit are adjacent to each other (continuously disposed), the odd-numbered wiring groups B[jodd] and the even-numbered wiring groups B[jeven] are alternately disposed. The odd-numbered wiring groups B[jodd] (jodd=1, 3, . . . , J−1) are an example of first signal line groups. The even-numbered wiring groups B[jeven] (jeven=2, 4, . . . , J) are an example of second signal line groups. Thus, the N signal lines 14 are included in the odd-numbered wiring groups B[jodd] (first signal line groups) and the even-numbered wiring groups B[jeven] (second signal line groups). Since the wiring groups B[jodd] as an example of the first signal line groups and the wiring groups B[jeven] as an example of the second signal line groups are alternately disposed, it is possible to make a difference in image quality between the pixel groups driven by data signals from the supply circuit inconspicuous.

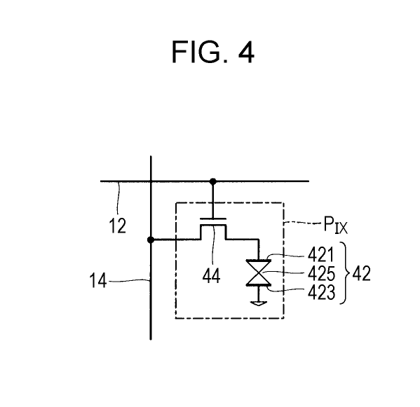

FIG. 4 is a circuit diagram of each pixel P_{IX}. Each pixel P_{Ix} is configured to include a liquid crystal element 42 and a selection switch 44. The liquid crystal element 42 is an example of an electrooptical element. The liquid crystal element 42 is configured with a pixel electrode 421 and a common electrode 423 that are opposed to each other, and a liquid crystal 425 interposed between both electrodes. The transmittance of the liquid crystal 425 changes according to the voltage applied between the pixel electrode 421 and the common electrode 423.

The selection switch 44 is configured with, for example, an N-channel type thin film transistor of which the gate is connected to the scanning line 12. The selection switch 44 is interposed between the liquid crystal element (pixel electrode 421) and the signal line 14, and controls the electrical connection (conduction/non-conduction) between the liquid crystal element 42 and the signal line 14. The pixel P_{IX} (liquid crystal element 42) displays the gradation according to the potential (gradation potential V_{G} to be described later) of the signal line 14 when the selection switch 44 is controlled to be in a turned-on state. Auxiliary capacitors and the like connected in parallel to the liquid crystal element 42 are not illustrated. The configuration of the pixel P_{IX} can be appropriately changed.

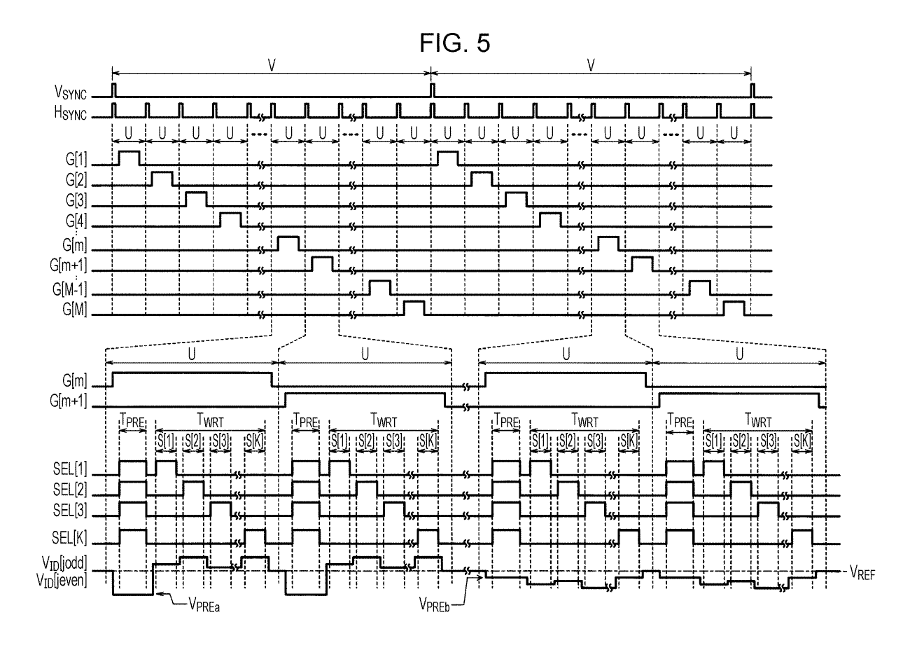

Returning to FIG. 3, the control circuit 500 controls the scanning line driving circuit 20, the first supply circuit 200a, and the second supply circuit 200b by using various signals including a synchronization signal. For example, the control circuit 500 supplies a vertical synchronization signal V_{SYNC} that defines a vertical scanning period V and a horizontal synchronization signal H_{SYNC} that defines a horizontal scanning period, as illustrated in FIG. 5, to the scanning line driving circuit 20, the first supply circuit 200a, and the second supply circuit 200b. Further, the control circuit 500 supplies image signals for designating the gradation of each pixel P_{IX} in a time-division manner, to the first supply circuit 200a and the second supply circuit 200b. The scanning line driving circuit 20, the first supply circuit 200a, and the second supply circuit 200b cooperate with each other to control the display of the pixel unit 10.

Typically, display data constituting one display screen is processed in a frame unit, and the processing period is one frame period (1F). The frame period F corresponds to the vertical scanning period V in a case where one display screen is formed by one vertical scanning.

As illustrated in FIG. 5, the scanning line driving circuit 20 sequentially selects the respective M scanning lines 12 according to the horizontal synchronization signal H_{SYNC}, by sequentially outputting the scanning signals G[1] to G[M] to the respective M scanning lines 12 for each unit period U. The unit period U is set to the time length of one cycle of the horizontal synchronization signal H_{SYNC} (horizontal scanning period (1H)).

As illustrated in FIG. 5, the scanning signal G[m] supplied to the scanning line 12 of the m-th row (m-th line) is set to the high level (potential indicating selection of the scanning line 12) in the m-th unit period U among the M unit periods U of each vertical scanning period V. The period for which the scanning line 12 is selected is also called a line period, and in this embodiment, substantially corresponds to the unit period U.

When the scanning line driving circuit 20 selects the scanning line 12 of the m-th row, the respective selection switches 44 of the N pixels P_{IX} of the m-th row transition to the turned-on state.

As illustrated in FIG. 5, the unit period U includes a precharge period T_{PRE} and a write period T_{WRT}.

The precharge period T_{PRE} is set before the start of the write period T_{WRT}. In FIG. 5, although one precharge period T_{PRE} is set before the write period T_{WRT}, a plurality (for example, two) of precharge periods T_{PRE} may be provided before the write period T_{WRT}.

In the write period T_{WRT}, the gradation potential V_{G} according to the designated gradation of each pixel P_{IX} is supplied to the respective signal line 14. In the precharge period T_{PRE}, predetermined precharge potential V_{PRE} (V_{PREa}, V_{PREb}) is supplied to the respective signal line 14.

The distribution circuit group 21 includes J distribution circuits 21[1] to 21[J]. The distribution circuits 21[1] to 21[J] respectively correspond to the wiring groups B[1] to B[J]. In this embodiment, a demultiplexer is used as each of the distribution circuits 21 [1] to 21[J].

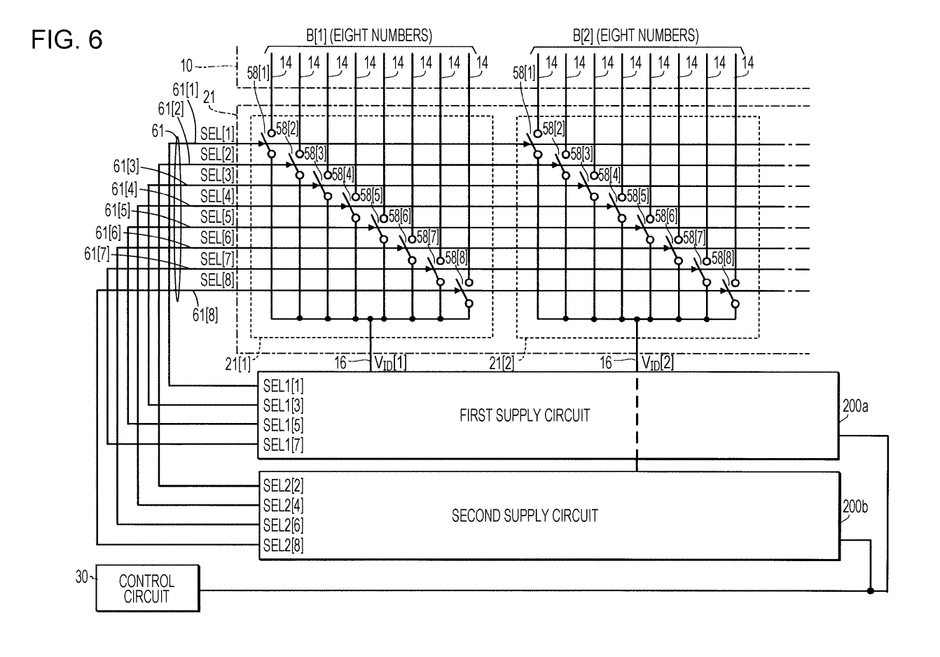

FIG. 6 is a diagram illustrating an example of the distribution circuit group 21, the first supply circuit 200a, and the second supply circuit 200b. In FIG. 6, as an example, the case of K=8 is illustrated.

The j-th distribution circuit 21[j] is configured to include 8 switches 58[1] to 58[8] corresponding to the 8 signal lines 14 of the j-th wiring group B[j].

The k-th (k=1 to 8) switch 58[k] in the distribution circuit 21[j] is interposed between the signal line 14 of the k-th column among the 8 signal lines 14 of the wiring group B[j] and the j-th data line 16 among the J data lines 16, and controls the electrical connection (conduction/non-conduction) between the k-th signal line 14 and the j-th data line 16.

The odd-numbered data lines 16 connect the first supply circuit 200a and the odd-numbered distribution circuits 21[jodd] via the first input unit 110a. The odd-numbered data lines 16 are an example of first data lines. The even-numbered data lines 16 connect the second supply circuit 200b and the even-numbered distribution circuits 21[jeven] via the second input unit 110b. The even-numbered data lines 16 are an example of second data lines.

The distribution circuits 21[j] are connected to the first supply circuit 200a via four selection signal lines 61[1], 61[3], 61[5] and 61[7] in a selection signal line group 61. The distribution circuits 21[j] are connected to the second supply circuit 200b via four selection signal lines 61[2], 61[4], 61[6] and 61[8] in the selection signal line group 61.

The first supply circuit 200a and the second supply circuit 200b generate data signals V_{ID}[1] to V_{ID}[J] based on the image signals from the control circuit 30, and supply the data signals to the data lines 16[1] to 16[J]. The data signals V_{ID}[1] to V_{ID}[J] include data signals V_{ID}[jodd] and data signals V_{ID}[jeven].

The first supply circuit 200a supplies the data signals V_{ID}[jodd] including, in a time-division manner, potential to be supplied to the respective signal lines 14 in the wiring groups B[jodd] (first signal line groups), to the distribution circuits 21[jodd] via the first input unit 110a and the jodd-th data lines 16. The potential is an example of a signal. The jodd-th data lines 16 are an example of first data lines. The first supply circuit 200a respectively supplies the data signals V_{ID}[jodd] in parallel. The data signals V_{ID}[jodd] supplied from the first supply circuit 200a are an example of first data signals.

The second supply circuit 200b supplies the data signals V_{ID}[jeven] including, in a time-division manner, potential to be supplied to the respective signal lines 14 in the wiring groups B[jeven] (second signal line groups), to the distribution circuits 21[jeven] via the second input unit 110b and the jeven-th data lines 16. The jeven-th data lines 16 are an example of second data lines. The second supply circuit 200b respectively supplies the data signals V_{ID}[jeven] in parallel. The data signals V_{ID}[jeven] supplied from the second supply circuit 200b are an example of second data signals.

The first data signals and the second data signals are so-called data signals, and are analog signals having different waveforms according to the display of an image, for example.

In this manner, the jodd-th data lines 16 as an example of the first data lines and the jeven-th data lines 16 as an example of the second data lines are alternately disposed side by side. In addition, since the first supply circuit 200a drives the odd-numbered wiring groups B[jodd] and the second supply circuit 200b drives the even-numbered wiring groups B[jeven], the pitch between the data lines 16 can be narrowed. Further, the first input unit 110a connected to the first supply circuit 200a and the second input unit 110b connected to the second supply circuit 200b are disposed side by side in the longitudinal direction (y direction) of the electrooptical panel 100. As a result, it is possible to display a high-definition image without increasing the size of the electrooptical panel 100 in the transverse direction (x direction).

Selection signals SEL[k] are supplied to the selection signal line group 61. The selection signals SEL[k] are timing signals for controlling the distribution of the data signals V_{ID}[j] to the K signal lines 14 which belong to each wiring group B[j].

The first supply circuit 200a outputs four first selection signals SEL1[1], SEL1[3], SEL1[5], and SEL1[7] for distributing the data signals V_{ID}[j] to the respective signal lines 14 in the wiring groups B[j], to the distribution circuit group 21. The first supply circuit 200a generates and outputs the four first selection signals. The first selection signals SEL1[k] are the selection signals SEL[k] output from the first supply circuit 200a.

The second supply circuit 200b outputs four second selection signals SEL2[2], SEL2[4], SEL2[6], and SEL2[8] for distributing the data signals V_{ID}[j] to the respective signal lines 14 in the wiring groups B[j], to the distribution circuit group 21. The second supply circuit 200b generates and outputs the four second selection signals. The second selection signals SEL2[k] are the selection signals SEL[k] output from the second supply circuit 200b.

In this embodiment, the first selection signals SEL1[k] and the second selection signals SEL2[k] are signals having the same waveform, and are pulse signals for turning on the switches 58[k] in the distribution circuits 21[j] for a predetermined time.

The first supply circuit 200a and the second supply circuit 200b use the same driver IC as an example, and each of the first supply circuit 200a and the second supply circuit 200b has a function of supplying eight selection signals. Therefore, in a case where the distribution circuit group 21 and the first supply circuit 200a are connected to each other by eight selection signal lines 61, the first supply circuit 200a can supply the eight selection signals via the eight selection signal lines 61. In addition, in a case where the distribution circuit group 21 and the second supply circuit 200b are connected to each other by eight selection signal lines 61, the second supply circuit 200b can supply the eight selection signals via the eight selection signal lines 61.

In this embodiment, the first supply circuit 200a is connected to the distribution circuit group 21 by four selection signal lines 61[1], 61[3], 61[5], and 61[7] (first selection signal lines) corresponding to the odd-numbered (refer to FIG. 5) selection signals SEL1[1], SEL1[3], SEL1[5], and SEL1[7], among the eight selection signal lines 61. In addition, the second supply circuit 200b is connected to the distribution circuit group 21 by four selection signal lines 61[2], 61[4], 61[6], and 61[8] (second selection signal lines) corresponding to the even-numbered (refer to FIG. 5) selection signals SEL2[2], SEL2[4], SEL2[6], and SEL2[8], among the eight selection signal lines 61.

In the example of FIG. 6, the first distribution circuit 21[1] and the second distribution circuit 21[2] in the distribution circuit group 21 are illustrated. The first selection signal lines 61[1], 61[3], 61[5], and 61[7] and the second selection signal lines 61[2], 61[4], 61[6], and 61[8] are connected to the first distribution circuit 21[1] in the distribution circuit group 21 so as to alternately correspond to the respective signal lines 14 in the wiring group B[1] as the first signal line group. Similarly, the first selection signal lines 61[1], 61[3], 61[5], and 61[7] and the second selection signal lines 61[2], 61[4], 61[6], and 61[8] are connected to the second distribution circuit 21[2] in the distribution circuit group 21 so as to alternately correspond to the respective signal lines 14 in the wiring group B[2] as the second signal line group.

In FIG. 6, although the case where K is 8 is illustrated as an example, the number of the selection signal lines 61 will be described using K as follows. Assuming that the number of the selection signal lines 61 connecting the second supply circuit 200b and the distribution circuit group 21 is P (P is a natural number of one or more), the first supply circuit 200a is connected to the distribution circuit group 21 by the K-P selection signal lines 61 (first selection signal lines). On the other hand, the second supply circuit 200b is connected to the distribution circuit group 21 by the P selection signal lines 61 (second selection signal lines). In the example of FIG. 6, the case where P (=4) is set to K/2 (8/2=4) is illustrated, and the number of the first selection signal lines is equal to the number of the second selection signal lines.

The first supply circuit 200a supplies the first selection signals SEL1[1], SEL1[3], SEL1[5] and SEL1[7] corresponding to the odd-numbered switches 58[1], 58[3], 58[5], and 58[7] in the distribution circuit group 21, via the first input unit 110a and the selection signal lines 61[1], 61[3], 61[5], and 61[7]. The second supply circuit 200b supplies the second selection signals SEL2[2], SEL2[4], SEL2[6] and SEL2[8] corresponding to the even-numbered switches 58[2], 58[4], 58[6], and 58[8] in the distribution circuit group 21, via the second input unit 110b and the selection signal lines 61[2], 61[4], 61[6], and 61[8].

The supply of the first selection signals SEL1[1], SEL1[3], SEL1[5], and SEL1[7] and the second selection signals SEL2[2], SEL2[4], SEL2[6], and SEL2[8] from the first supply circuit 200a and the second supply circuit 200b is controlled by the control circuit 500. In this embodiment, the first selection signal SEL1[1], the second selection signal SEL2[2], the first selection signal SEL1[3], the second selection signal SEL2[4], the first selection signal SEL1[5], the second selection signal SEL2[6], the first selection signal SEL1[7], and the second selection signal SEL2[8] are supplied in this order. In this manner, the control circuit 500 does not supply the second selection signals when the first selection signals are supplied, and does not supply the first selection signals when the second selection signals are supplied. That is, the control circuit 500 exclusively supplies the first selection signals and the second selection signals.

The distribution circuits 21[jodd] included in the distribution circuit group 21 distribute the data signals V_{ID}[jodd] to the respective eight signal lines 14 in the wiring groups B[jodd], by using the selection result of the first supply circuit 200a and the second supply circuit 200b. The distribution circuits 21[jeven] included in the distribution circuit group 21 distribute the data signals V_{ID}[jeven] to the respective eight signal lines 14 in the wiring groups B[jeven], by using the selection result of the first supply circuit 200a and the second supply circuit 200b.

Next, an outline of the operation of the electrooptical device 1 will be described.

The first supply circuit 200a generates the data signals V_{ID}[jodd] (first data signals) that designate, in a time-division manner, the gradation of the pixels P_{IX} corresponding to the respective signal lines 14 in the wiring groups B[jodd].

The second supply circuit 200b generates the data signals V_{ID}[jeven] (second data signals) that designate, in a time-division manner, the gradation of the pixels P_{IX} corresponding to the respective signal lines 14 in the wiring groups B[jeven].

The first supply circuit 200a further generates the first selection signals SEL1[1], SEL1[3], SEL1[5], and SEL1[7]. The second supply circuit 200b generates the second selection signals SEL2[2], SEL2[4], SEL2[6], and SEL2[8].

The control circuit 500 controls the supply of the first selection signals and the second selection signals. The order of the supply is the order of the first selection signal SEL1[1], the second selection signal SEL2[2], the first selection signal SEL1[3], the second selection signal SEL2[4], the first selection signal SEL1[5], the second selection signal SEL2[6], the first selection signal SEL1[7], and the second selection signal SEL2[8].

The distribution circuit group 21 distributes the data signals V_{ID}[jodd] to the respective signal lines 14 in the wiring groups B[jodd], by using the first selection signals SEL1[1], SEL1[3], SEL1[5], and SEL1[7] and the second selection signals SEL2[2], SEL2[4], SEL2[6], and SEL2[8]. Further, the distribution circuit group 21 distributes the data signals V_{ID}[jeven] to the respective signal lines 14 in the wiring groups B[jeven].

According to this embodiment, the second selection signals are not supplied when the first selection signals are supplied, and the first selection signals are not supplied when the second selection signals are supplied. Therefore, it is possible to equally distribute the load of the supply of the selection signals in the supply circuits to the first supply circuit 200a and the second supply circuit 200b. As a result, it is possible to effectively prevent deterioration in image display, compared to a case where the selection signals are supplied by a single supply circuit. The first selection signals and the second selection signals are pulse signals, and noise in the GND potential may occur at the rising edges and the falling edges of the pulse signals. However, as in this embodiment, the supply of the selection signals is distributed by the first supply circuit 200a and the second supply circuit 200b, and thus it is possible to prevent the occurrence of noise in each of the first supply circuit 200a and the second supply circuit 200b. In addition, as described above, the number of the first selection signals and the number of the second selection signals are both set to four, and the first selection signals and the second selection signals are equally distributed by the first supply circuit 200a and the second supply circuit 200b. Therefore, it is possible to prevent a difference in load between when the first supply circuit 200a supplies the first selection signals and when the second supply circuit 200b supplies the second selection signals. Thus, it is possible to prevent the occurrence of a difference such as a decrease in luminance.

In this embodiment, although the N signal lines 14 are divided into the J wiring groups B[j] each with the K signal lines 14 as one unit that are continuously disposed in the transverse direction, the N signal lines 14 may be divided into the J wiring groups B[j] each with the K signal lines 14 as one unit that are not continuously disposed in the transverse direction. For example, the signal lines 14 which belong to the wiring groups B[jodd] and the signal lines 14 which belong to the wiring groups B[jeven] may be alternately disposed. The odd-numbered signal lines 14 belong to the wiring groups B[jodd], and the even-numbered signal lines 14 belong to the wiring groups B[jeven]. Even in this case, it can be said that the wiring groups B[jodd] and the wiring groups B[jeven] are odd-numbered wiring groups and even-numbered wiring groups.

The first data signals and the first selection signals are signals supplied from the first supply circuit 200a. The first signal line groups, the first data lines, and the first selection signal lines are wiring and wiring groups to which the signals from the first supply circuit 200a are supplied. In addition, the second data signals and the second selection signals are signals supplied from the second supply circuit 200b. The second signal line groups, the second data lines, and the second selection signal lines are wiring and wiring groups to which the signals from the second supply circuit 200b are supplied.

### MODIFICATION EXAMPLE

The above embodiments can be modified in a variety of other forms. Specific modification forms are exemplified below. Two or more forms arbitrarily selected from the following examples can be appropriately combined unless the forms are inconsistent with each other.

### Modification Example 1

In the above-described embodiment, the number K-P of the first selection signal lines connected to the first supply circuit 200a and the number P of the second selection signal lines connected to the second supply circuit 200b are set to be equal to each other, P being set to K/2. However, the invention is not limited to such a configuration, and P may be set to a number other than K/2. Even in this case, it is possible to distribute the load of the supply of the selection signals in the supply circuits to the first supply circuit 200a and the second supply circuit 200b. As a result, it is possible to effectively prevent deterioration in image display, compared to a case where the selection signals are supplied by a single supply circuit.

### Modification Example 2

In the above-described embodiment, although the first supply circuit 200a and the second supply circuit 200b capable of originally supplying the K (=8) selection signals are used, a first supply circuit 200a and a second supply circuit 200b capable of supplying K (=4) selection signals from the beginning may be used. In this case, it is possible to reduce the chip area of the first supply circuit 200a and the second supply circuit 200b. In a case where the chip area is the same as that of the first supply circuit 200a and the second supply circuit 200b capable of supplying K (=8) selection signals, since it is sufficient to supply K (=4) selection signals, it is possible to increase the size of an output transistor. As a result, it is possible to ensure a sufficient driving capability corresponding to a panel with high resolution.

### Modification Example 3

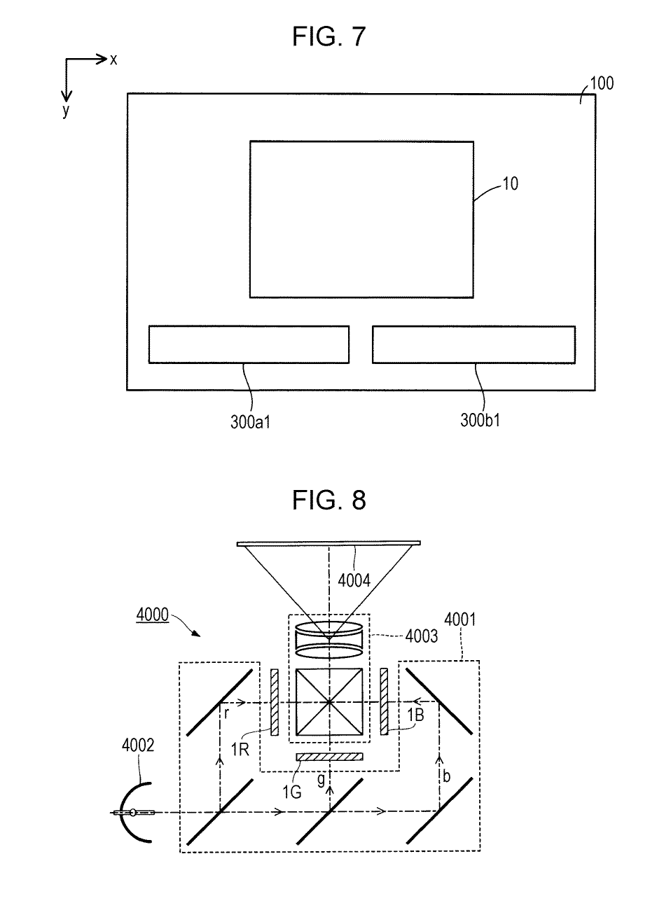

In the above-described embodiments, as illustrated in FIGS. 1 and 2, a configuration in which the flexible printed circuit board 300a and the flexible printed circuit board 300b are attached so as to overlap each other when viewed from the display direction (z direction) of the electrooptical panel 100 is described. However, the invention is not limited to such a configuration. For example, as illustrated in FIG. 7, the connection terminal 300a1 for connecting the flexible printed circuit board 300a and the connection terminal 300b1 for connecting the flexible printed circuit board 300b may be disposed on the electrooptical panel 100 side by side in the transverse direction (x direction) of the electrooptical panel 100. In this case, it is easy to mount the flexible printed circuit board 300a and the flexible printed circuit board 300b on the electrooptical panel 100. However, in this example, compared to the configuration in which the connection terminal 300a1 and the connection terminal 300b1 illustrated in FIGS. 1 and 2 are disposed in the longitudinal direction (y direction), there is a case where mounting regions of the flexible printed circuit board 300a and the flexible printed circuit board 300b become larger with respect to the pixel unit 10, or a case where the wiring connecting the pixel unit 10 and the mounting regions becomes longer.

### Modification Example 4

The number of the wiring boards connected to the electrooptical panel 100 is not limited to two. Three or more wiring boards may be connected to the electrooptical panel 100. Even in this case, the supply circuits of the respective wiring boards output the selection signals such that the load is equally distributed.

### Modification Example 5

In the example of FIG. 3, an example in which one end of the selection signal line group 61 is connected to the first supply circuit 200a or the second supply circuit 200b and in which the first selection signals and the second selection signals are supplied is described. However, both ends of the selection signal line group 61 may be connected to the first supply circuit 200a or the second supply circuit 200b. In this case, the first selection signals SEL1 and the second selection signals SEL2 may be supplied from both ends of the selection signal line group 61. Also, the first selection signals SEL1 may be supplied from one end of the selection signal line group 61, and the second selection signals SEL2 may be supplied from the other end of the selection signal line group 61.

### APPLICATION EXAMPLE

The electrooptical device 1 exemplified in each of the above embodiments and modification examples can be used for various electronic apparatuses. FIG. 8 illustrates a specific form of an electronic apparatus in which the electrooptical device 1 is adopted.

FIG. 9 is a schematic diagram of a projection type display apparatus (three plate type projector) 4000 to which the electrooptical device 1 is applied. The projection type display apparatus 4000 is configured to include three electrooptical devices 1 (1R, 1G, and 1B) corresponding to different display colors (red, green, and blue). An illumination optical system 4001 supplies red components r among light emitted from an illumination device (light source) 4002 to the electrooptical device 1R, supplies green components g to the electrooptical device 1G, and supplies blue components b to the electrooptical device 1B. Each of the electrooptical devices 1 functions as an optical modulator (light valve) that modulates monochromatic light supplied from the illumination optical system 4001 according to the display image. A projection optical system 4003 combines the light emitted from the respective electrooptical panels 100 and projects the combined light on a projection surface 4004. The electrooptical device 1 is applied, and thus it is possible to realize a compact projection type display apparatus 4000 capable of high-definition display.

The electronic apparatuses to which the electrooptical device according to the invention is applied include a portable personal computer, a personal digital assistants (PDA), a digital still camera, a television, a video camera, and a car navigation device, in addition to the apparatus illustrated in FIG. 9. Further, the electronic apparatuses include an in-vehicle display apparatus (instrument panel), an electronic organizer, an electronic paper, a calculator, a word processor, a workstation, a video phone, a POS terminal, a printer, a scanner, a copier, a video player, an apparatus including a touch panel, and the like.

The entire disclosure of Japanese Patent Application No. 2016-146171, filed Jul. 26, 2016 is expressly incorporated by reference herein.

What is claimed is:

1. An electrooptical device comprising:
a plurality of first pixels that are disposed corresponding to the respective intersections between a plurality of first signal lines which belong to a first signal line group and a plurality of scanning lines, and that display gradation according to first data signals supplied to the first signal lines when the scanning lines are selected;
a plurality of second pixels that are disposed corresponding to the respective intersections between a plurality of second signal lines which belong to a second signal line group and a plurality of scanning lines, and that display gradation according to second data signals supplied to the second signal lines when the scanning lines are selected;
a first distribution circuit that distributes the first data signals to the first signal lines according to first selection signals or second selection signals;
a second distribution circuit that distributes the second data signals to the second signal lines according to first selection signals or second selection signals;
a first supply circuit that supplies the first data signals and the first selection signals;
a second supply circuit that supplies the second data signals and the second selection signals; and
a control circuit that exclusively supplies the first selection signals and the second selection signals.

2. An electrooptical device comprising:
a plurality of pixels that are disposed corresponding to the respective intersections between 2K (K is a natural number of two or more) or more signal lines and two or more scanning lines, and that display gradation according to signals supplied to the signal lines when the scanning lines are selected;
a scanning line driving circuit that sequentially selects the respective scanning lines;
a first supply circuit that supplies first data signals to the respective signal lines in first signal line groups each with the K signal lines via first data lines, and that supplies first selection signals via K-P (P is a natural number of one or more) first selection signal lines;
a second supply circuit that supplies second data signals to the respective signal lines in second signal line groups each with the K signal lines different from the K signal lines which belong to the first signal line groups via second data lines, and that supplies second selection signals via P second selection signal lines;
a first distribution circuit that is connected to the respective signal lines in the first signal line groups, the first data lines, the K-P first selection signal lines, and the P second selection signal lines, and that supplies the first data signals to the respective signal lines in the first signal line groups according to the first selection signals or the second selection signals supplied via the first selection signal lines or the second selection signal lines;
a second distribution circuit that is connected to the respective signal lines in the second signal line groups, the second data lines, the K-P first selection signal lines, and the P second selection signal lines, and that supplies the second data signals to the respective signal lines in the first signal line groups according to the first selection signals or the second selection signals supplied via the first selection signal lines or the second selection signal lines; and
a control circuit that exclusively supplies the first selection signals from the first supply circuit and the second selection signals from the second supply circuit.

3. The electrooptical device according to claim 2,
wherein P is K/2.

4. The electrooptical device according to claim 3,
wherein the K-P first selection signal lines and the P second selection signal lines are connected to the first distribution circuit so as to alternately correspond to the respective signal lines in the first signal line groups, and are connected to the second distribution circuit so as to alternately correspond to the respective signal lines in the second signal line groups.

5. The electrooptical device according to claim 2,
wherein the first supply circuit has a function of supplying the first selection signals via the K first selection signal lines or the second selection signal lines, and
wherein the second supply circuit has a function of supplying the second selection signals via the K second selection signal lines.

6. The electrooptical device according to claim 1,
wherein the first supply circuit is provided on a first wiring board,
wherein the second supply circuit is provided on a second wiring board, and
wherein the first wiring board and the second wiring board are attached so as to overlap each other when viewed from the display direction of the pixels.

7. The electrooptical device according to claim 5,
wherein the first data lines and the second data lines are alternately disposed side by side.

8. The electrooptical device according to claim 1,
wherein a plurality of the first signal line groups and a plurality of the second signal line groups are respectively provided, and
wherein the first signal line groups and the second signal line groups are alternately disposed.

9. An electronic apparatus comprising:
the electrooptical device according to claim 1.

10. An electronic apparatus comprising:
the electrooptical device according to claim 2.

11. An electronic apparatus comprising:
the electrooptical device according to claim 3.

12. An electronic apparatus comprising:
the electrooptical device according to claim 4.

13. An electronic apparatus comprising:
the electrooptical device according to claim 5.

14. An electronic apparatus comprising:
the electrooptical device according to claim 6.

15. An electronic apparatus comprising:
the electrooptical device according to claim 7.

16. An electronic apparatus comprising:
the electrooptical device according to claim 8.

17. A method for driving an electrooptical device, comprising:
supplying first data signals and first selection signals by a first supply circuit;
supplying second data signals and second selection signals by a second supply circuit;
distributing the first data signals to first signal lines according to the first selection signals or the second selection signals, by a first distribution circuit;
distributing the second data signals to second signal lines according to the first selection signals or the second selection signals, by a second distribution circuit;
displaying gradation according to the first data signals supplied to the first signal lines when scanning lines are selected, by first pixels that are disposed corresponding to respective intersections between the first signal lines and the scanning lines;
displaying gradation according to the second data signals supplied to the second signal lines when the scanning lines are selected, by second pixels that are disposed corresponding to respective intersections between the second signal lines and the scanning lines; and
exclusively supplying the first selection signals from the first supply circuit and the second selection signals from the second supply circuit, by a control circuit.
